(19) United States
(12) Patent Application Publication
(10) Pub. No.: US 2010/0018467 A1
(43) Pub. Date: Jan. 28, 2010

(54) Automated feeding apparatus

(76) Inventor: René Massicotte, Batiscan (CA)

Correspondence Address: Franz BONSANG;c/o EQUINOX PROTECTION, 410 - 1500, Du College, St-Laurent, QC, H4L 5G6, CA

(21) Appl. No.: 12/585,758

(22) Filed: Sep. 24, 2009

Related U.S. Application Data
(63) Continuation-in-part of application No. 11/156,638, filed on Jun. 21, 2005, now abandoned.
(60) Provisional application No. 60/581,456, filed on Jun. 22, 2004.

(51) Int. Cl. A01K 5/00

(52) U.S. Cl. 119/57.7; 119/61.3

(57) ABSTRACT

An automated feeding apparatus for animals includes a compartmented feed storage container provided with an upper hinged access door for charging the feed into the compartments, which are provided with automatically or manually operable discharge doors. The container is so dimensioned that the discharge doors in their closed and open positions are shielded from an animal feeding from the apparatus. A deflector plate is disposed beneath the discharge doors and is so mounted as to allow and accommodate unintended movement thereof, for example movement occasioned by an animal.

### CROSS-REFERENCE TO RELATED APPLICATIONS

The present application is a Continuation-In-Part (C.I.P.) of application Ser. No. 11/156,638 filed on Jun. 21, 2005, now abandoned, and benefit of U.S. Provisional Application for Patent Ser. No. 60/581,456, filed on Jun. 22, 2004, is hereby claimed.

### FIELD OF THE INVENTION

The present invention relates to feeding apparatuses for animals and methods, and is more particularly concerned with such an apparatus for automatically, or manually, feeding pellets and/or hay to horses.

### BACKGROUND OF THE INVENTION

It is well known in the art to have a feeder for animals such as horses and the like. U.S. Pat. No. 3,845,744 issued to H. Carr on Nov. 5, 1974 provides for a feeder with a relatively complex mechanism for opening the doors one by one and ensuring that the system closes all doors when the lid is opened. Moreover, the constriction of the hopper could potentially block or choke the delivery of feed to the animal(s) with perturbing circumstances. Finally, the lid being positioned above the feeder significantly hampers the delivery of heavy bags of pellets, for example, which must be lifted above the feeder. U.S. Pat. No. 5,899,169 issued to B. Jenson et al. on May 4, 1999 shows hayracks which, if strong enough not to be damaged by the animal, provide for a more complicated and probably heavier feeder to build. In addition, a hazard will always exists on this design with an automatic opening of one of the doors while an animal is eating, potentially hurting the nose or nostrils of the animal.

U.S. Pat. No. 5,970,912 issued to K. Supple et al. on Oct. 26, 1999 discloses a feeder that generally releases all the food contained therein at a certain time. It is therefore necessary to reload the feeder regularly and this, only for one type of food material. Furthermore, in this invention also there is a hazard that the tray or the armature structure could hurt the animal when the controller releases the tray open. U.S. Pat. No. 6,715,443 issued to A. Bernard on Apr. 6, 2004 provides for some of the same disadvantages as earlier described. One can consider for example the difficulty to fill the device without having to release it from the support structure and the potential to harm the animal with one of the bottom walls or with the protruding pin component when the bottom wall is released open.

Accordingly, there is a need for an improved automated feeder apparatus for animals.

### SUMMARY OF THE INVENTION

It is therefore a general object of the present invention to provide an improved automated feeder apparatus for animals.

An advantage of the present invention is that the feeder apparatus provides for a feeding mechanism designed to avoid hurting the muzzle of the animal, more specifically the nose, nostrils and mouth.

Another advantage of the present invention is that the feeder apparatus provides for a protected feeding mechanism in order to avoid being damaged by the muzzle of the animal.

A further advantage of the present invention is that the feeding apparatus has at least two separate feed lines providing for two types of food material that can be delivered simultaneously or consecutively and that provides for either an automated or manual activation.

Still another advantage of the present invention is that the feeding apparatus provides for an easily accessible horizontal access to the feeding area for filling and refilling the different types of food material for the animals.

Still a further advantage of the present invention is that the feeding apparatus holds separate feed section and a feed deflector.

Another advantage of the present invention is that the feeding apparatus provides for a delivery of the food material without blocking.

Still a further advantage of the present invention is that the feeding apparatus provides for at least one of the feeds that can be partially activated to deliver only a limited quantity of food material at a given time.

Still another advantage of the present invention is that the feeding apparatus provides for a simple, economically sound and easy to manufacture mechanical arrangement.

Another advantage of the present invention is that the feeding apparatus may be situated within an animal stable or box or externally thereof, dependent upon the nature of the stable facility.

According to an aspect of the present invention, there is provided a feeding apparatus for animals consisting of a box structure comprising a hinged upper front door, a secured lower front panel, a top panel, a pair of side panels, a back panel, the upper front door and lower front panel, side and back panels bordering a series of compartments for feed materials, each of the compartments being provided with a lower hinged discharge door, a door locking and opening system adapted to activate the respective lower hinged discharge door to open to enable feed materials to fall by gravity towards a feed area and an independent door closing system adapted to close the lower hinged discharge doors, the lower front panel, the side panels and the back panel being configured and sized to extend downwardly enough to enclose the lower hinged discharge doors when in an open position, and an angularly orientable deflector plate being disposed beneath the discharge doors and being adjustably attached to deflector plate supports through the agency of pin and slot arrangements, the deflector plate in use deflecting the feed materials falling from the discharge doors towards the feed area, and some of the deflector plate supports being mountable in such manner as in use to accommodate movement by an external force.

The movable supports may conveniently be pivotally mounted.

The pin and slot arrangements may be provided respectively on the deflector plate and on the deflector plate supports.

Each pin and slot arrangement comprises a pin slidably mounted in both a corresponding support slot of the deflector plate support and a corresponding plate slot of the deflector plate, the pin being slidably movable simultaneously in both the corresponding support slot and the plate slot.

The deflector plate is conveniently provided beneath the discharge doors to facilitate flow of the feed materials to the feed area which may simply be the ground or may be a feed trough for the animals. The angular inclination of the deflector plate is adjustable to afford a degree of modulation to cater for differing feed consistencies or feed rates.

The deflector plate may be mounted on plate supports connected to the apparatus and mounting feet may be advantageously mounted at a lower end of the plate supports in such manner as to allow of the movement hereinbefore mentioned.

A separate compartment or compartments may be provided for other feed materials, for example granular feeds, which may benefit from different conveying regimes. In one example of the invention the conveying regime may comprise a screw feeder for transporting the feed from the compartment to a receptor, for example a manger or feed pan, suitably disposed for ease of access by the animal.

Each lower hinged discharge door may be unitary or may be formed in two separate parts each essentially comprising a half-door. In the case where half-doors are adopted integrated operation thereof may be provided for by means of a simple lever and over-centre arrangement of the door locking and opening system and the door closing system.

The control of the feeding apparatus may be such as to allow incremental feeding by for example stepwise opening of the lower discharge doors.

A portion of the feeding apparatus of the invention may be electrified to protect it from inadvertent damage by the animal. In the alternative the whole of the apparatus is electrified.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, wherein:

FIG. 1 is a simplified front perspective view of a feeding apparatus in accordance with an embodiment of the present invention, with the upper front door in the open position showing access to the feed compartments on the refill side;

FIG. 2 is a simplified rear perspective view of the embodiment of FIG. 1, showing the discharge side, namely the animal side, of the apparatus;

FIG. 3 is a side view of the apparatus shown in situ on the outside of a horse loose box or stable;

FIGS. 4 to 6 are section views taken along line 4-4 of FIG. 1, showing the stages of closure of the lower hinged discharge doors;

FIGS. 7 to 12 illustrate an alternative form of lower hinged discharge door arrangement;

FIGS. 13 to 15 show schematically an alternative operating arrangement for the lower hinged discharge doors;

FIG. 16 shows a discharge system for granular feed materials;

FIG. 17 is a perspective front view of a feeding apparatus according to the invention showing a further embodiment of a detail thereof; and

FIG. 18 is a scrap side view of the details shown in FIG. 17.

### DETAILED DESCRIPTION OF THE PREFERRED EMBODIMENTS

With reference to the annexed drawings the preferred embodiments of the present invention will be herein described for indicative purpose and by no means as of limitation with like numerals of reference being employed for like parts in differing embodiments of the invention or its details.

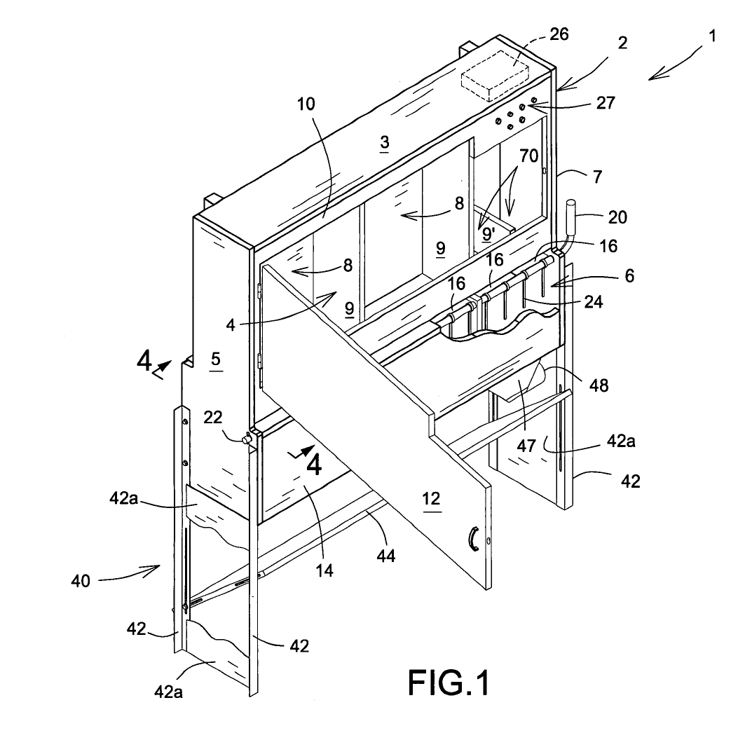

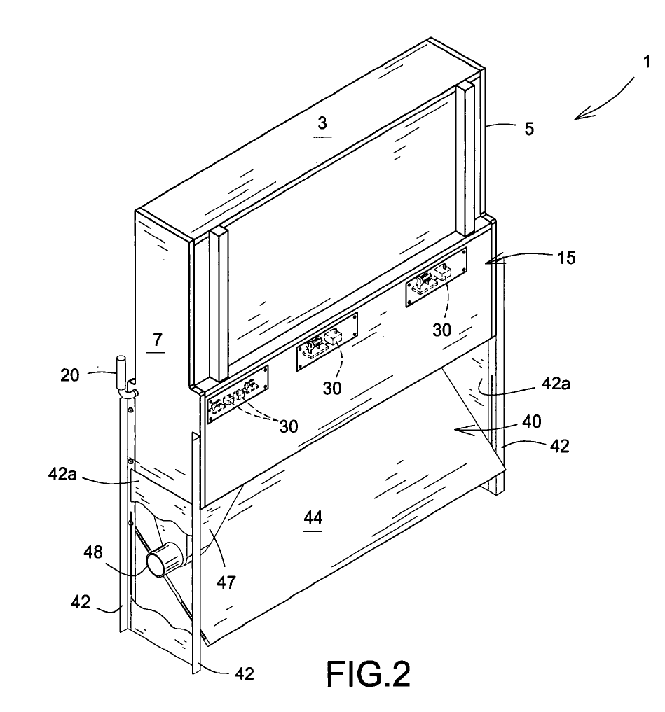

Referring first to FIGS. 1 to 3 there is schematically shown a feeding apparatus 1 in accordance with the present invention. The apparatus essentially consists of a box structure 2 having an upper feed or input region 4 with a top panel 3 and a relatively lower discharge region 6 defined between front 14 and end panels 5, 7.

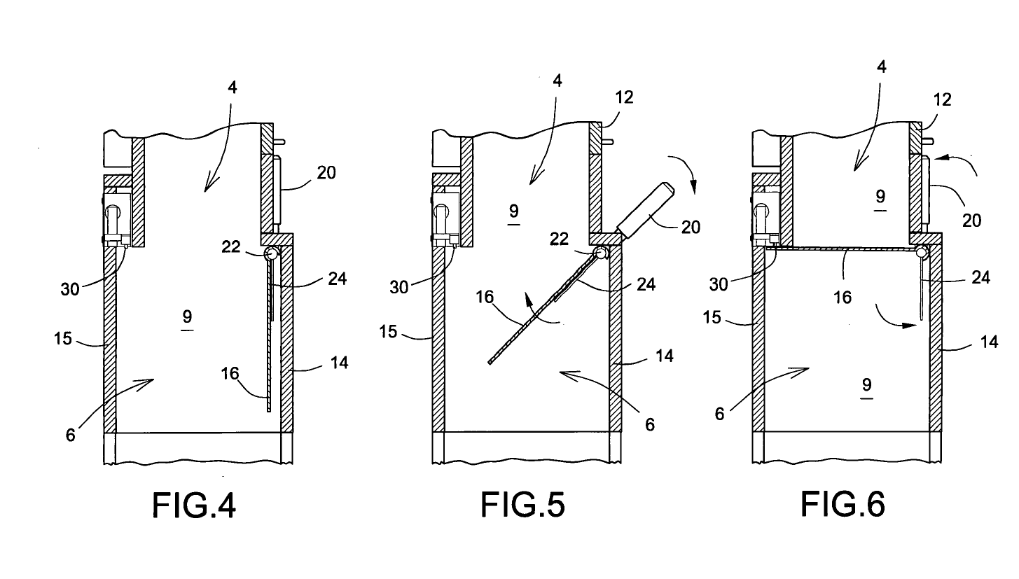

The upper feed region 4 comprises a series of compartments 8, 70 (two hay compartments 8 and two smaller pellet end compartments 70 shown in FIG. 1 for example) separated by partition walls 9, 9′ accessed through a common opening 10 closable by a hinged upper front door 12 (FIG. 1) superposing a lower fixed front panel 14. The rear or animal side of the upper feed region is closed by a back panel 15. Each compartment 8 is provided with a lower hinged discharge door 16 within the lower discharge region 6, the doors 16 being actuable for closure by a handle 20 of a door closing system suitably mounted externally of the upper and lower regions as shown. The handle 20 is carried by and is rigid with a shaft 22 provided with a plurality of tines 24 which co-operate with the doors as more clearly seen in FIGS. 4 to 6. An electro-magnetic lock 30 of a door locking and opening system may be provided for each door 16 to maintain it in a closed position (FIG. 6) and to release it into an open position (FIG. 4) as and when required, repositioning of the door into the closed position being effected by suitable movement of the handle 20 and thus the tines 24 (FIG. 5). A programmable timer 26 (shown in dotted lines in FIG. 1, above the end compartments 70) with corresponding control panel 27 may conveniently be provided for actuation of the locks 30 which may operate simultaneously or sequentially in timed fashion. The handle 20 and shaft 22 are typically maintained in a parked position shown in FIGS. 1, 5 and 6 by a biasing spring or the like (not shown).

The lower discharge region 6 is defined between the end panels 5, 7 which are fixed and between lower front 14 and back 15 panels which are also fixed, the lower hinged discharge doors 16 being wholly contained within the confines of the end panels 5, 7 and the front 14 and back 15 panels.

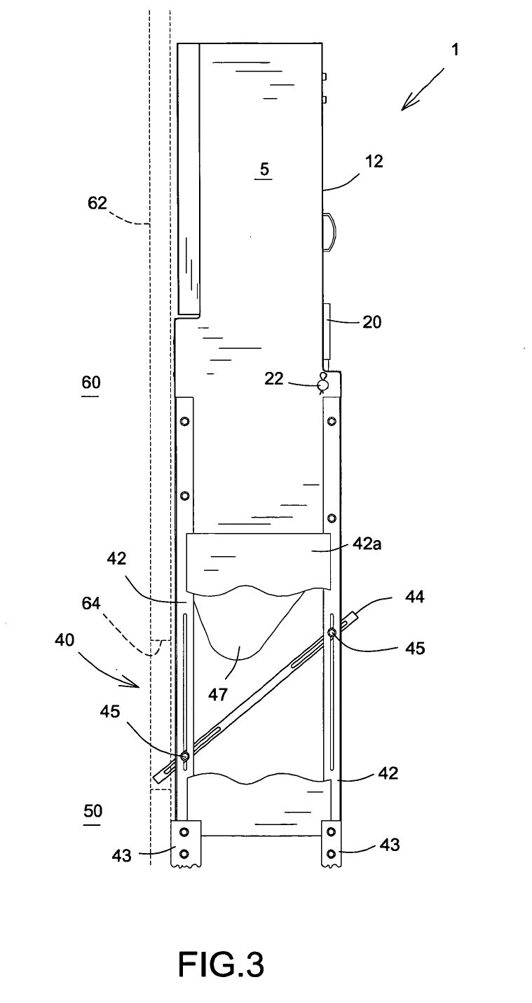

A discharge zone 40 is provided subjacent the discharge region 6 and is in one embodiment as shown in FIGS. 1, 2 and 3 constrained between deflector plate supports 42 situated at the corners of the box structure 2 and their optional side walls 42a. The discharge zone 40 accommodates a feed deflector plate 44 for conveying the feed in use from beneath the discharge doors 16 to a feed area 50 within a horse loose box 60, one wall 62 of which is shown in dotted outline in FIG. 3. In this instance, the feeding apparatus 1 is situated exteriorly of the loose box 60 and is affixed to the wall 62. The advantage of this arrangement is that recharging of the apparatus with fresh supplies of feed may be effected without having to gain access to the loose box. The feed deflector plate 44 is angularly adjustable and to this end is provided in association with the plate supports 42 with pin and slot arrangements 45, with each arrangement 45 having a pin slidably engaged and simultaneously slidably movable in both in a corresponding plate slot and a corresponding plate support slot of preferably equal length. Thus, the plate may be disposed at a suitable, and reversible, inclination to assist flow of the feed material, for example hay, in register with an access opening 64 of the wall 62. Typically, the plate supports 42 remain spaced from the floor (not shown) to ensure that there is enough room for the animal's legs to move around without hitting the apparatus. Optionally, mounting feet 43 could be releasably affixed to the lower end of plate supports 42 to help supporting the weight of the apparatus 1 via the floor.

In an alternative embodiment the feeding apparatus is located with the box 60 with access being provided externally thereof through the upper door 12.

In further alternative embodiments the plate supports 42 may be omitted, a deflector plate if required being independently situated in an appropriate position.

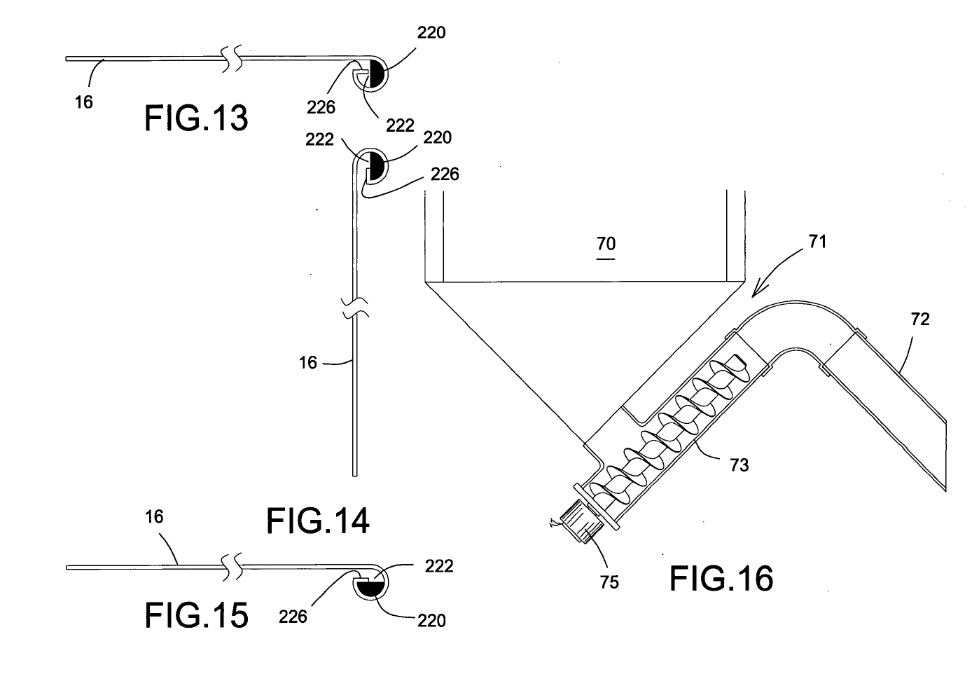

The upper feed region 4 is additionally provided with end compartments 70 (separated by partition wall 9′) for containing granular feed and is provided with a corresponding hopper 47 and outlet 48 instead of the deflector plate 44 to redirect the flow of pellet or the like there from toward a separate container, trough or the like (not shown). Alternatively, the end compartments 70 are provided with a screw conveyor 71 (FIG. 16 in particular) with a discharge outlet 72 leading from the screw section 73. An electric motor 75 is provided for powering the rotation of the screw section 73 and may be actuated by the controller 26 on a timed and duration basis to give the appropriate feed amounts delivered periodically as required.

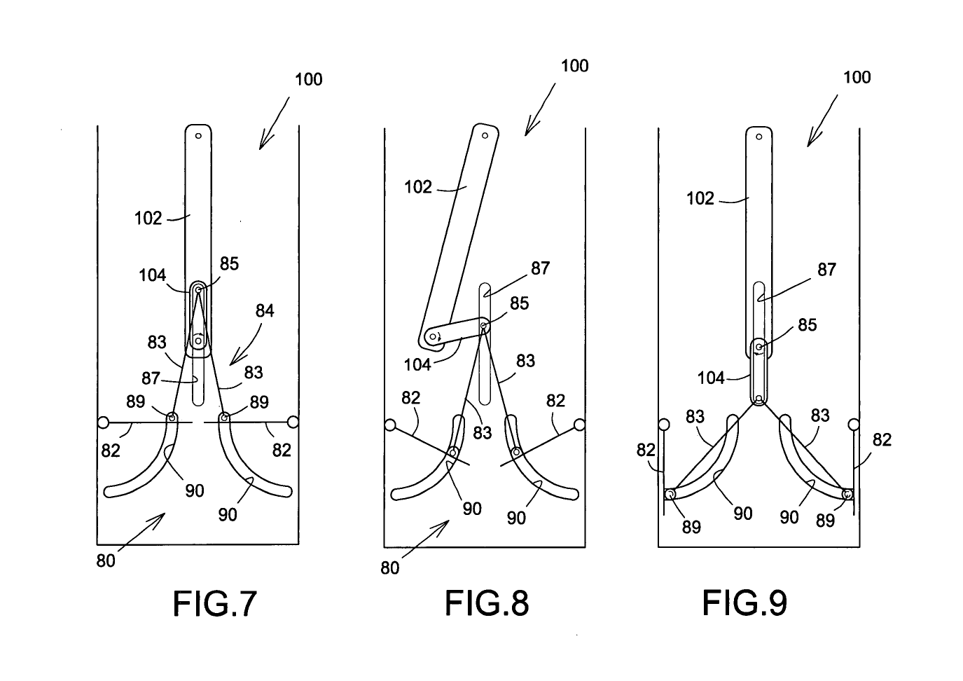

Referring now specifically to FIGS. 7 to 12, there is shown in illustrative manner an alternative lower hinged discharge door arrangement combining the door locking and opening system with the door closing system. In particular there is depicted a half-door assembly 80 in which each discharge door comprises two half doors 82 hingedly mounted on the confining front and rear walls or panels and interconnected by a mechanical linkage 84 including two operating limbs 83 pivoted together by a pin 85 movable in a crosshead 87. Each half door 82 has a lynch pin 89 connected to a respective limb 83, the pins 89 being movable within arcuate slots 90. A crank lever assembly 100 is provided as an actuating mechanism for moving the half doors in unison between their open and closed positions. Each assembly 100 has a pivoted main crank 102 pivoted to a throw 104 connected to the pin 85. In operation from the closed position of the half doors 82, clockwise movement of the crank 102 pulls the limbs 83 upwardly as viewed in the drawing via the throw 104 and the movement of the doors is described visually in FIGS. 7 through 9 in which last figure the doors assume an open position. FIGS. 10 through 12 illustrate the reverse movement from an open position to a closed position. Movement of the half doors 12 may be effected manually or automatically as desired.

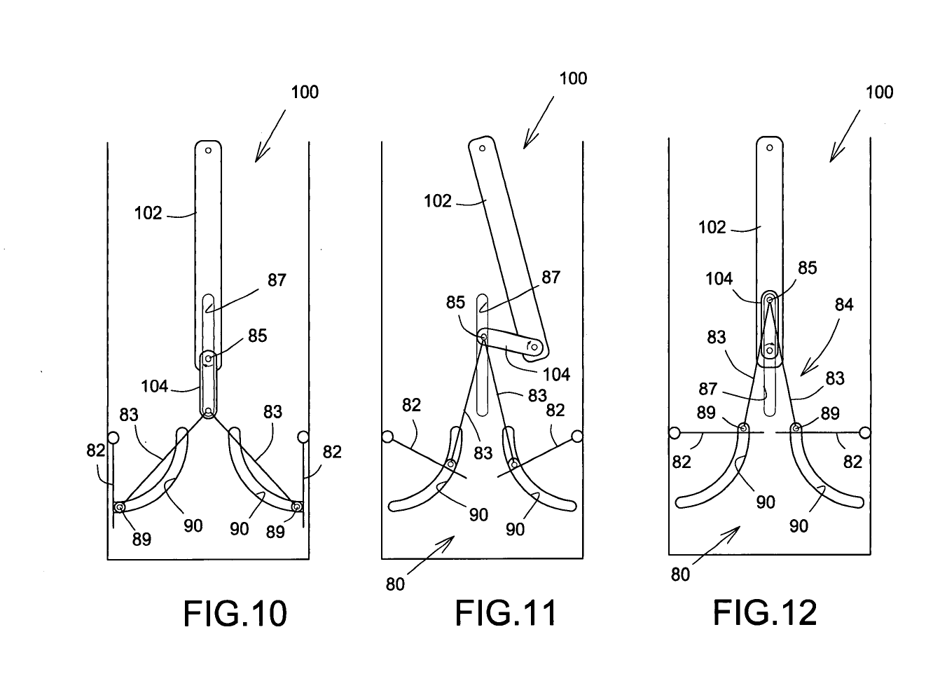

Referring now to FIGS. 13 to 15, there is depicted an alternative form of operating shaft 220 of a door closing system for the doors 16 in which the shaft is provided with one or a series of flats 222 corresponding to the number of doors. The flats are engageable with in-turned cooperating flanges 226 provided on the door hinges 228 whereby abutment of the flats 222 with the flanges 226 and rotation of the shaft 220 effects movement of the doors. FIG. 13 shows the door 16 closed and locked by an electromagnet in that position, with the shaft 220 in the parked position. FIG. 14 shows the door in the open position with the flat abutting the flange 226. Rotation of the shaft from the position shown in FIG. 14 takes the door into the closed horizontal position shown in FIG. 15; after which the shaft 22 will typically return in the parked position as shown in FIG. 13.

In operation of the apparatus of the present invention, feed is charged through the common opening 10 and door 12 into the compartments 8 and is held there by the doors 16. When desired the doors are opened either automatically or manually to release the feed within the apparatus to descend under the influence of gravity onto the deflector plate 44. The doors in the fully open position are wholly confined within the discharge zone and are not contactable by the animal feeding from the materials discharged.

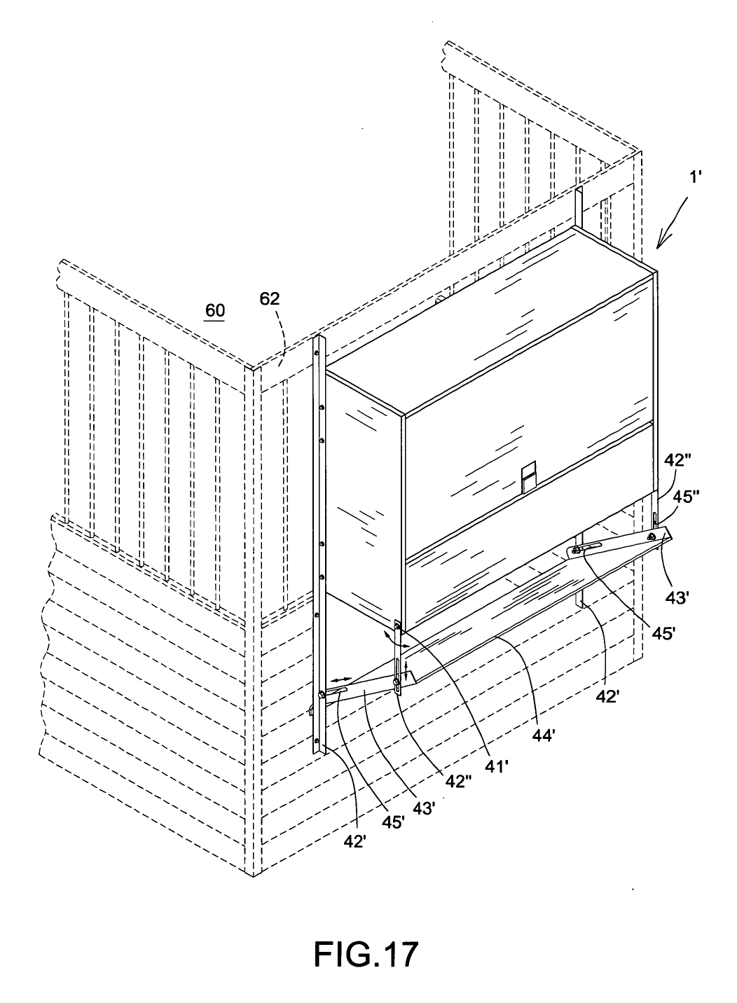

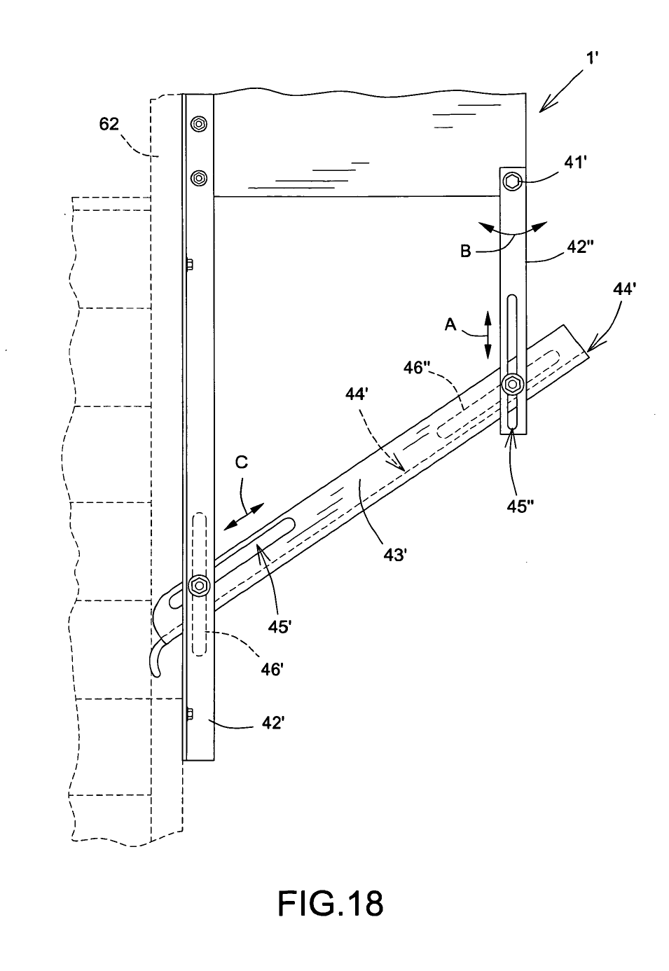

Referring now to FIGS. 17 and 18 there is illustrated the wall 62 of a loose box 60 with a feed apparatus 1′ of generally similar configuration as that shown and described in the earlier figures. The apparatus differs in respect of the deflector plate 44′ and its support legs 42′, 42″. In these respects the deflector plate 44′ has upturned sides 43′ which are adjustable attachable to the legs 42′ through the agency of pin and slot arrangements 45′, 45″. In this particular embodiment a lockable pin and slot arrangement 45′ is provided separately in each of the sides 43′ and a lockable pin and slot arrangement 45″ is provided separately on each of the support legs 42′, the pins on the sides 43′ engaging slots on the legs 42′ and the pins on the legs respectively engaging the slots on the sides 43′. The support legs 42′ are secured to the wall 62 while the support legs 42″ are secured to the apparatus 1′ by means of a pivot pin mount 41′ which is adapted to allow some movement of the plate 44′ relative thereto upon application of an external force of a predetermined level, especially using spacers at the mounting of support legs 42″ at pivot pin mounts 41′. In this manner, should an animal, for example a horse, nudge or otherwise move the plate 44′, the resulting movement of the latter will be accommodated by virtue of the pivotal mount 41′. It will be understood that the lockable pin and slot arrangements are normally locked in position, but not sufficiently tightly to prevent sliding movement of the pins relative to the slots.

As will be seen from FIGS. 17 and 18 should a horse nudge the deflector plate 44′ in the direction of arrow A, the plate 44′ will move upwardly and in so doing will cause the leg 42″ to pivot about its mount 41′ along the path designated B and the plate 44′ will also move in the direction of arrow C. This movement is compensatory to avoid damage that would otherwise be sustained in the absence of articulation of this kind. The angular setting of the plate 44′ can readily be re-established by appropriate adjustment.

Accordingly, the plate is yieldable in response to outside forces to the extent of the slot dimension. It will readily be understood by the skilled addressee that a variety of pin and slot arrangements may be employed to lend versatility to the positioning of the deflector plate 44′. For example the arrangements illustrated in FIGS. 1, 2 and 3 could be adopted in combination with the embodiment of FIGS. 17 and 18 to allow repositioning of the plate to any desired angular disposition, as exemplified by slots 46′ and 46″ shown in dotted lines in FIG. 18.

The present invention thus provides a simple and yet effective feeding apparatus for an animal, for example a horse, and enables feeding to be conducted automatically or manually and without the need for a physical presence of a groom in the loose box or the stable. Recharging of the feed materials is easily effected externally of the area within which the animal is kept.

An important feature of the invention resides in the confinement of the lower hinged discharge doors which are not contactable by the animal during use, thus avoiding damage to either the animal or the apparatus.

In a further refinement of the invention, the apparatus may be provided with protection against accidental and inadvertent damage caused by the animal. In this connection, the apparatus or parts thereof may be electrified as a warning measure to keep the animal away there from. The animal would thus receive a mild shock in the event that it contacts a sensitive part of the mechanism, for example the control panel.

Although the present invention of a feeding apparatus has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A feeding apparatus for animals consisting of a box structure comprising a hinged upper front door, a secured lower front panel, a top panel, a pair of side panels, a back panel, the upper front door and lower front panel, side and back panels bordering a series of compartments for feed materials, each of the compartments being provided with a lower hinged discharge door, a door locking and opening system adapted to activate the respective lower hinged discharge door to open to enable feed materials to fall by gravity towards a feed area and an independent door closing system adapted to close the lower hinged discharge doors, the lower front panel, the side panels and the back panel being configured and sized to extend downwardly enough to enclose the lower hinged discharge doors when in an open position, and an angularly orientable deflector plate being disposed beneath the discharge doors and being adjustably attached to deflector plate supports through the agency of pin and slot arrangements, the deflector plate in use deflecting the feed materials falling from the discharge doors towards the feed area, and some of the deflector plate supports being mountable in such manner as in use to accommodate movement by an external force.

2. A feeding apparatus according to claim 1 wherein the said at least some of the deflector plate supports are pivotally mounted.

3. A feeding apparatus according to claim 2 wherein the pin and slot arrangements are provided respectively on the deflector plate and on the deflector plate supports.

4. A feeding apparatus according to claim 1 wherein each pin and slot arrangement comprises a pin slidably mounted in both a corresponding support slot of the deflector plate support and a corresponding plate slot of the deflector plate, the pin being slidably movable simultaneously in both the corresponding support slot and the plate slot.

5. A feeding apparatus according to claim 1 wherein mounting feet are mounted at a lower end of some of the deflector plate supports.

6. A feeding apparatus according to claim 1 wherein a separate compartment is provided for a feed material and separate conveying means is provided therefor.

7. A feeding apparatus according to claim 6 wherein the separate conveying means is a screw conveyor.

8. A feeding apparatus according to claim 1 wherein each lower hinged discharge door is unitary.

9. A feeding apparatus according to claim 1 wherein the lower hinged door is formed of two halves.

10. A feeding apparatus according to claim 9 wherein each half door is separately pivoted.

11. A feeding apparatus according to claim 10 wherein the half doors are adapted to move in unison.

12. A feeding apparatus according to claim 11 wherein the door locking and opening system and the door closing system include a crank arrangement for actuating the half doors.

13. A feeding apparatus according to claim 1 wherein the lower hinged discharge doors are mounted on a common shaft of the door closing system and are actuable by a series of tines.

14. A feeding apparatus according to claim 1 wherein the lower hinged discharge doors are mounted on a common shaft of the door closing system provided with a flat or a series of flats engageable with a cooperating flange provided on each door whereby upon abutment between the flat and the flanges movement of the door is effected.

15. A feeding apparatus according to claim 1 wherein the door locking and opening system includes an electromagnetic lock for each lower hinged discharge door to retain the door in a closed position across the compartment.

16. A feeding apparatus according to claim 1, further including means to electrify the apparatus in its entirety to generate a shock upon contact therewith.
